(19) United States
(12) Patent Application Publication
(10) Pub. No.: US 2026/0121385 A1
(43) Pub. Date: Apr. 30, 2026

(54) ELECTRICAL PANEL FOR AN AIRCRAFT

(71) Applicant: Airbus Operations SAS, TOULOUSE (FR)

(72) Inventors: Matthieu DE KERGOMMEAUX, TOULOUSE (FR); Benjamin BOISNIER, TOULOUSE (FR); Jean-Andre CAZALBON, TOULOUSE (FR)

(21) Appl. No.: 19/368,601

(22) Filed: Oct. 24, 2025

(30) Foreign Application Priority Data
Oct. 30, 2024 (FR) FR2411874

(51) Int. Cl. H02B 1/04; H01H 71/02; H01H 71/04

(52) U.S. Cl. CPC H02B 1/042; H01H 71/0221; H01H 71/0271; H01H 71/04

(57) ABSTRACT

An electrical panel, for an aircraft, with a front plate, a rear plate, a PCB plate with an information processing unit, and a power supply plate for the power supply of at least one circuit breaker. The PCB plate and the power supply plate arranged between the front plate and the rear plate. Each of the plates has at least one passage orifice for the circuit breaker.

### CROSS-REFERENCE TO RELATED APPLICATIONS

This application claims priority to French Patent Application No. FR2411874, filed on Oct. 30, 2024, the entire disclosure of which is incorporated herein by way of reference.

### FIELD OF THE INVENTION

The present invention relates to an electrical panel for an aircraft.

### BACKGROUND OF THE INVENTION

An aircraft includes many items of electrical equipment connected to each other by complex electrical circuits and equipped with circuit breakers to ensure the safety of the equipment. Such electrical circuits require a large number of wires, which are both bulky and time consuming to prepare.

The aim of the invention is to at least partially overcome these drawbacks.

### SUMMARY OF THE INVENTION

For this purpose, the invention proposes an electrical panel for an aircraft, comprising a first plate, referred to as the front plate, a second plate, referred to as the rear plate, a third plate comprising a printed circuit, referred to as the PCB plate, the PCB plate comprising an information processing unit, a fourth plate for the electrical supply of at least one circuit breaker, referred to as the electrical supply plate, the PCB plate and the electrical supply plate being arranged between the front plate and the rear plate, each of the plates being provided with at least one through-orifice for a circuit breaker.

The electrical panel according to the present invention saves space on account of its flat shape, and is easy to install, on account of its succession of plates, and also the electrical supply plate, which reduces the number of cables required.

According to another aspect, said at least one through-orifice for a circuit breaker are superposed so as to allow the circuit breaker to pass through each of the orifices provided.

According to another aspect, the electrical panel comprises an electrical insulation plate between the electrical supply plate and the PCB plate.

According to another aspect, the rear plate comprises at least one housing for installing said circuit breaker.

According to another aspect, the PCB plate comprises a label containing electrical ink, the information processing unit being configured to instruct the electrical ink of the label to display visual information.

According to another aspect, the electrical panel comprises means for determining its own positioning relative to an electrical diagram of the aircraft, designed to communicate with the information processing unit.

According to another aspect, the electrical panel comprises means for locking the circuit breaker in the electrical panel.

The invention also relates to a circuit breaker for an electrical panel as described above, comprising means for identifying the circuit breaker.

According to another aspect, the circuit breaker comprises means for displaying a locked state of the circuit breaker in the electrical panel and an unlocked state of the circuit breaker.

The invention also relates to an electrical cabinet for an aircraft, comprising at least one electrical panel as described above and/or at least one circuit breaker as described above.

The invention also relates to an aircraft, comprising at least one electrical panel as described above and/or at least one circuit breaker as described above and/or at least one electrical cabinet as described above.

### BRIEF DESCRIPTION OF THE DRAWINGS

Other features, details and advantages will appear from reading the detailed description below, and from analyzing the attached drawings, in which:

FIG. 1 is a schematic front perspective view of an electrical panel according to the present invention;

FIG. 2 is a schematic exploded view of the electrical panel in FIG. 1;

FIG. 3 is a schematic perspective view of the electrical panel in FIG. 2;

FIG. 4 is another schematic perspective view of a detail of the panel in FIG. 1;

FIG. 5 is a rear perspective view of the panel in FIG. 1;

FIG. 6 is a schematic view of the distribution of the electric current in the electrical panel in FIG. 1.

FIG. 7 is a schematic perspective view of a circuit breaker, disassembled, for the electrical panel in the preceding figures;

FIG. 8 is another schematic perspective view of the circuit breaker in FIG. 7; and,

FIG. 9 is a schematic view of an electrical cabinet equipped with a plurality of electrical panels.

### DETAILED DESCRIPTION OF THE PREFERRED EMBODIMENTS

The examples and the related conditions detailed here are mainly intended to help the reader understand the principles of the present invention and not to limit its scope to these specific examples and conditions. It will be understood that a person skilled in the art can conceive of various arrangements which, although not explicitly described or represented here, nevertheless embody the principles of the present invention and are included in its spirit and scope.

Furthermore, to facilitate understanding, the following description may describe relatively simplified implementations of the present invention. As a person skilled in the art will understand, other implementations of the present invention may be of greater complexity.

In some cases, examples of modifications of the present invention may also be presented. This is done simply as an aid to understanding, and again not to define the scope or establish the limits of the present invention. These modifications are not an exhaustive list, and a person skilled in the art may make other modifications while still remaining within the scope of the present invention.

Furthermore, all the statements below relating to the principles, aspects and implementations of the present invention, as well as the specific examples thereof, aim to encompass both the structural and functional equivalents thereof, whether they are currently known or developed in the future.

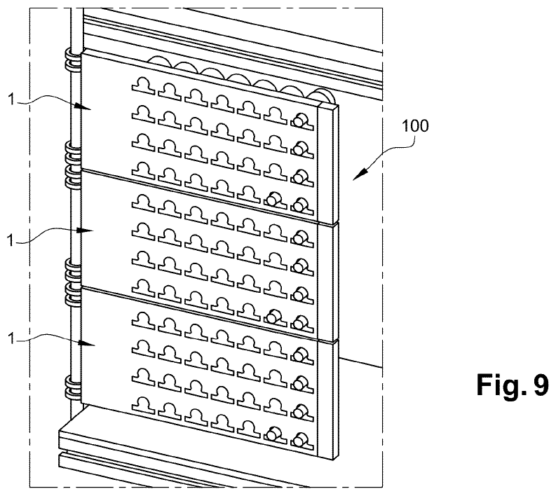

The invention relates to an electrical panel, referenced 1 in the figures, for an aircraft. The electrical panel 1 is installed in an electrical cabinet 100, otherwise referred to as an avionics bay, as illustrated in FIG. 9. FIG. 9 shows three electrical panels 1.

The electrical panel 1 is intended to receive circuit breakers 2. Each of the circuit breakers 2 is dedicated to an electrical circuit for an item of electrical equipment of the aircraft. As detailed below, when the circuit breaker 2 is locked (or engaged) in the electrical panel 1, an electrical current flows in the electrical circuit to which it is dedicated. When the circuit breaker 2 is unlocked from the electrical panel 1, the electrical supply is cut off in the dedicated circuit.

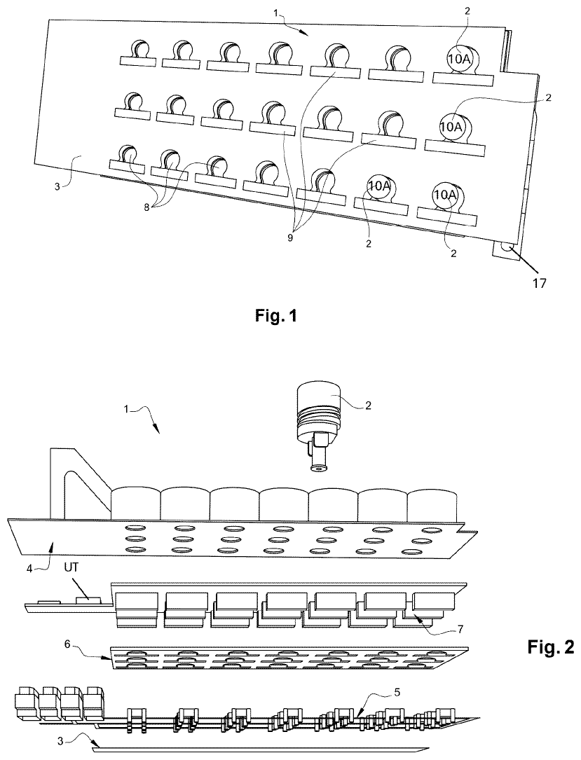

As shown in FIGS. 1 to 8, the electrical panel 1 comprises a set of plates secured to one another. The panel 1 comprises a first plate, referred to as the front plate 3, and a second plate, referred to as the rear plate 4, between which are arranged, from the front plate 3 to the rear plate 4, an electrical supply plate 5, an electrical insulation plate 6, and a printed-circuit-board (PCB) plate 7.

The plates 3 to 7 are stacked on one another and the contours of the inner plates 5, 6 and 7 are of the same dimensions or of smaller dimensions than the outer plates, which are the front plate 3 and the rear plate 4, thereby giving the electrical panel 1 a generally flat rectangular shape.

As can be seen particularly in FIG. 1, the front plate 3 has a generally rectangular shape. The front plate 3 comprises orifices 8 arranged, in a non-limiting manner, in three rows of seven orifices 8. Each of the orifices 8 is dimensioned to receive a circuit breaker 2 and a label 9 associated with each orifice 8. Each label 9 is a visual indicator of the identity of the circuit breaker 2, as detailed below.

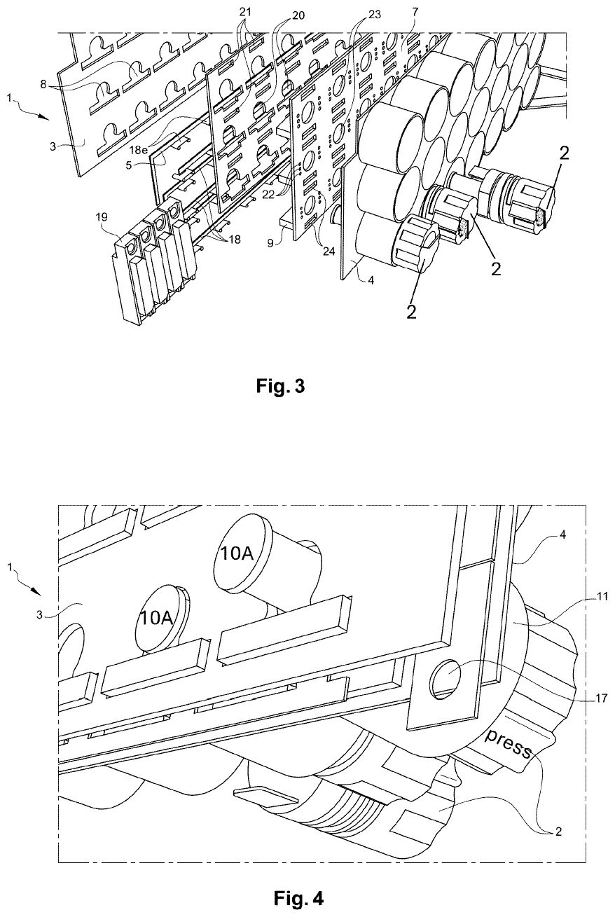

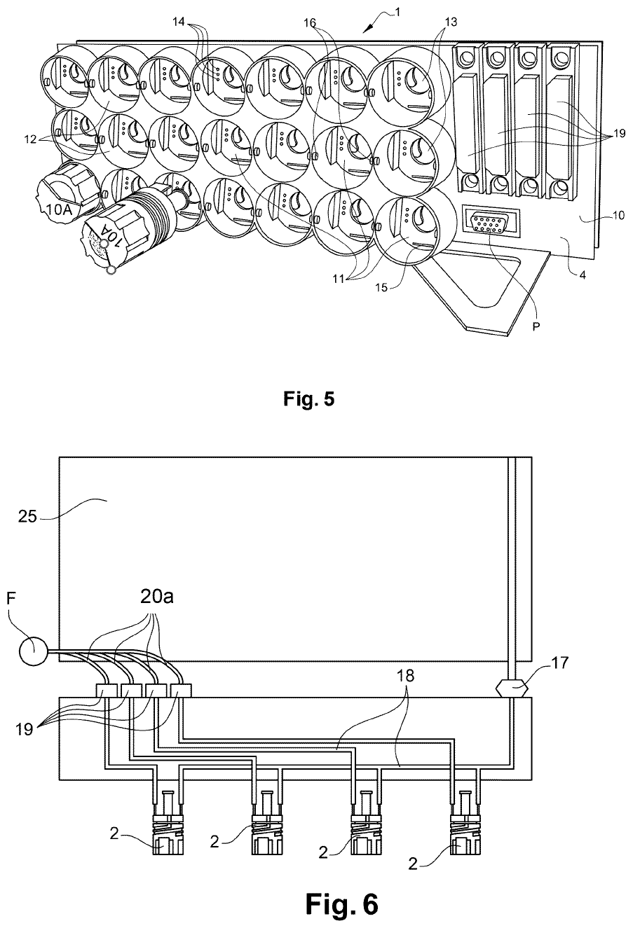

As can be seen particularly in FIGS. 3 and 5, the rear plate 4 has a generally rectangular shape. The rear plate 4 comprises a plate 10 surmounted by a set of housings 11, each housing 11 being designed to receive a circuit breaker 2. In the figures, and in a non-limiting manner, the housings 11 are organized in three rows of seven.

Each housing 11 is a cylinder with a circular opening 12 which rests on the plate. For each housing 11, the plate itself contains orifices 13 of diameter smaller than the circular opening 12, each orifice 13 being coaxial with the associated opening 12. The plate 10 also comprises small holes 14 (in FIG. 5, a row of three for each housing 11) and a rectilinear slot 15.

Each housing 11 comprises two diametrically opposed studs 16 for locking the circuit breaker 2 in the housing 11, as described in detail below.

As can be seen particularly in FIGS. 3, 4 and 6, the electrical supply plate 5 comprises an electrical supply input 17, connected to electrically conductive rods 18, or bus bar. The plate 5 also comprises a set of outputs 19 intended to be connected to equipment of the aircraft by cables 20a grouped in a bundle F. Each rod 18 is provided with lugs 18e projecting toward the electrical insulation plate 6.

It will be noted that the plate 5 is essentially empty and the term plate is used because the contour of the rods 18 is substantially rectangular.

As can be seen particularly in FIG. 3, the electrical insulation plate 6 has a generally rectangular shape. The plate 6 comprises through-orifices 20 for the circuit breakers 2 and labels 9 and rectilinear slots 21.

As can also be seen in FIG. 3, the PCB plate 7 has a generally rectangular shape. The plate 7 comprises a printed circuit, as well as an information processing unit UT, or microprocessor, connected to the printed circuit. The microprocessor is configured to control an electronic ink, to print characteristics relating to the circuit breakers 2 on the labels 9. The PCB plate 7 also comprises small holes 22 and circular orifices 23 and rectilinear slots 24.

The distribution of the electric current is described below in table 1, with reference to FIG. 6.

As shown in this figure, in the operating position, an electrical power supply center 25 is electrically connected to the electrical power supply input 17. The conductive rods 18, connected to the input 17, supply power in series to the circuit breakers 2. Each of the circuit breakers 2 is connected by one of the outputs 19 to an item of equipment of the aircraft.

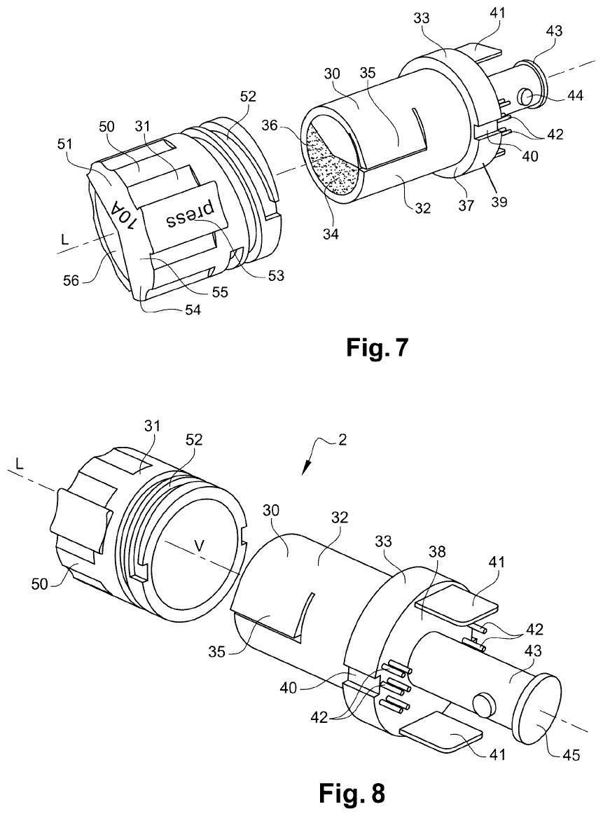

A circuit breaker 2 intended to be connected in the electrical panel 1 is described in detail below with reference to FIGS. 7 and 8.

As shown in these figures, each circuit breaker 2 is generally cylindrical in shape including an electrical connection cylinder 30 and a cap 31, of longitudinal axis L.

The electrical connection cylinder 30 comprises a longitudinal wall 32 extending between a base 33 and a top 34. The longitudinal wall 32 is provided with two diametrically opposed pawls 35. The top 34 is provided with a visual indicator 36. The visual indicator 36 is a disk having one sector of a first color and a second sector of a second color. In the figures, the colors are green and red, green (120° sector) indicating that the circuit breaker 2 is connected and red (240° sector) indicating that the circuit breaker 2 is not connected, as explained below.

The base 33 comprises a ring-shaped part 37 and a base 38 arranged on the two sides of a longitudinal wall 39. The ring-shaped part 37 is intended to receive the cap 31. The longitudinal wall 39 is provided with two diametrically opposing grooves 40. Each groove 40, preferably straight, is a guide for one of the studs 16 of the housings 11 of the rear plate 4.

The electrical connection cylinder 30 also comprises two contact plates 41, for receiving the electric current, projecting from the base. The electrical connection cylinder 30 also comprises pins 42, for example two sets of pins 42, referred to as auxiliary contact pins. The pins 42 indicate the status of the circuit breaker 2. An internal resistor, not illustrated, is associated with a given status. For example, and without limitation, a 10Ω resistor is used for a rating of 2 A, a 100Ω resistor for a rating of 5 A, a 200Ω resistor for 10 A, a 300Ω resistor for 16 A, etc.

As also shown in FIGS. 7 and 8, the electrical connection cylinder 30 comprises a rod 43, preferably a central rod, arranged along the longitudinal axis L. The rod 43 comprises at least one button 44. The button 44 preferably comprises a chip. The button 44 indicates the rating and presence of the circuit breaker 2, and whether the circuit breaker 2 is connected in the electrical panel 1, as detailed below. The free end 45 of the rod 43 bears an inscription of the amperage, i.e. the rating, of the circuit breaker 2 (for example 2 A, 5 A, 10 A, 16 A, etc.).

The cap 31 is a hollow cylinder, comprising a longitudinal wall 50 and a top 51. An internal volume V is delimited between the top 51 and the longitudinal wall 50. The internal volume V is dimensioned to receive the electrical connection cylinder 30. The longitudinal wall 50 is provided with a thread 52 for locking the circuit breaker 2 in the rear plate 4. The longitudinal wall 50 is also provided with two buttons 53 for locking/unlocking a respective pawl 35 of the electrical connection cylinder 30. The top 51 has a part 54 in the form of an angular sector bearing an indication 55 of the amperage of the circuit breaker 2 (for example 2 A, 5 A, 10 A, 16 A, etc.). The angular sector is the same as the sector of the disengagement color (for example red, illustrated by dots in the figures). The top 51 also comprises an opening 56, in the form of an angular sector corresponding to the sector of the engagement color (for example, green, illustrated in white in the figures).

To assemble the circuit breaker 2, the electrical connection cylinder 30 is inserted into the cap 31 until the top 51 rests on the ring-shaped part 37 of the electrical connection cylinder.

In the assembled position, the top 51 of the cap 31 reveals the red section of the electrical connection cylinder 30. Two lead-ins 57 of the thread 52 of the cap 31 are arranged in line with a respective groove 40 of the connection cylinder 30. The pawls 35 retain the buttons 53 and prevent the cap 31 from rotating.

To install the circuit breaker 2 in the electrical panel 1, the circuit breaker 2 must first be inserted through the circular opening 12 of its respective housing 11. The studs 16 are then slid into one of the grooves 40 as far as the lead-in 57 of the thread 52. The buttons 53 are then pressed, which releases the pawls 35 and enables the cap 31 to be rotated, the studs 16 moving in the thread 52 to the position locking the circuit breaker 2 in the housing 11.

In the locked position, the pins 42 are arranged in the small holes 14 of the rear plate 4, and the small holes 22 of the PCB plate, which ensures communication between the circuit breaker 2 and the microprocessor. Each plate 41 passes through a rectilinear slot 15 in the rear plate 4, a rectilinear slot 24 in the PCB plate and a rectilinear slot 21 in the insulation plate 6, and rests against the lugs 18e of the electrical supply plate 5, which enables the electrical circuit to be powered, as already described. The central rod 43 passes through the orifice 13 in the housing 11, the orifice 23 in the PCB plate, the orifice 20 in the electrical insulation plate 6 and the orifice 8 in the front plate 3. The end of the rod 43 is visible and shows the inscription of the amperage of the circuit breaker 2 (for example 2 A, 5 A, 10 A, 16 A, etc.). In this position, the green sector is visible, which visually indicates to an operator that the circuit breaker 2 is connected, locked, in the electrical panel 1.

The electrical panel 1 comprises means for determining the identity of the panel. Identity means its positioning in the electrical cabinet 100. For example, this is electrical panel number N in the electrical cabinet 100, which is itself the number M in the general electrical layout of the aircraft. In this case, the identity of the electrical panel is N, M.

The determination means is connected to a control unit (for example a motherboard which manages all the electrical panels 1, or at least some of them), which sends it the identity of the panel 1. This is referred to as a declaration of position.

The declaration of position comes either from the connection of a socket with a specific addressing (internal connection), or from the connection of a smart CAN bus to a network, or from an update via the Internet or a specific network or artificial intelligence.

According to a first variant, the means is a socket and, depending on the cables connected to the socket, the control unit informs it of the identity of the panel 1.

According to a second variant, the connected cables are the same and the distinction is made by using distinct resistors (for example, a first position in the panel is 10 ohms, a second position is 100 ohms, a third position is 200 ohms, etc.).

According to a third variant, a switch connected to the socket ensures the declaration of address.

According to a fourth variant, a screw provides an electrical contact for the declaration of address.

The identity of the circuit breaker 2 is communicated to the microprocessor by reading the button (chip) 44, as shown in FIG. 8.

Once the position of the electrical panel is known, the microprocessor is able to identify the name and rating to display on each label, using electronic ink.

For example, the labels 9 may contain the following messages: ventilation 10A, lighting 20A, etc.

The microprocessor is also configured to compare the identity of the circuit breaker communicated to it by the control unit via the socket P with the identity of the circuit breaker communicated to it by the pins 42 of the circuit breaker 2. If the identities do not match, the microprocessor displays an error message on the label 9.

The microprocessor is also configured to detect whether the circuit breaker 2 is fully inserted, thanks to the button 44 which is used to indicate the rating and presence of the circuit breaker 2, and whether the circuit breaker 2 is connected in the electrical panel 1.

Thus, a first role is to check that the correct amperage is in place (5 A in a 5 A location, for example) and to provide the electronic ink with the intended “postal” address (i.e. the intended labeling). A second role is to determine, by proximity, whether the circuit breaker 2 is switched on (for example, powering a downstream light or not) “ON” or “OFF”.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An electrical panel for an aircraft comprising:
a first plate, referred to as a front plate;
a second plate, referred to as a rear plate;
a third plate comprising a printed circuit, referred to as a PCB plate, the PCB plate comprising an information processing unit; and,
a fourth plate for an electrical supply of at least one circuit breaker, referred to as an electrical supply plate, the PCB plate and the electrical supply plate arranged between the front plate and the rear plate,
wherein each of the first plate, the second plate, the third plate, and the fourth plate comprises at least one through-orifice for the at least one circuit breaker.

2. The electrical panel as claimed in claim 1, further comprising:
an electrical insulation plate between the electrical supply plate and the PCB plate.

3. The electrical panel as claimed in claim 1, wherein the rear plate comprises at least one housing for installing said at least one circuit breaker.

4. The electrical panel as claimed in claim 1, wherein the PCB plate comprises a label containing electrical ink, the information processing unit configured to instruct the electrical ink of the label to display visual information.

5. The electrical panel as claimed in claim 1, further comprising:
means for determining a positioning of the electrical panel relative to an electrical diagram of the aircraft, the means for determining configured to communicate with the information processing unit.

6. The electrical panel as claimed in claim 1, further comprising:
means for locking the at least one circuit breaker in the electrical panel.

7. A circuit breaker comprising:
the electrical panel as claimed in claim 1; and,
means for identifying the circuit breaker.

8. The circuit breaker as claimed in claim 7, further comprising:
means for displaying a locked state of the circuit breaker in the electrical panel and an unlocked state of the circuit breaker.

9. An electrical cabinet for an aircraft, comprising:
at least one circuit breaker as claimed in claim 7.

10. An aircraft comprising:
the electrical cabinet as claimed in claim 9.
